(19) United States
(12) Patent Application Publication
(10) Pub. No.: US 2026/0359291 A1
(43) Pub. Date: Nov. 12, 2026

(54) DATA-AWARE MIXTURE OF EXPERTS AGENTIC QUERY

(71) Applicant: Palo Alto Networks, Inc., Santa Clara, CA (US)

(72) Inventor: Chenghung Pan, Palo Alto, CA (US)

(21) Appl. No.: 19/201,707

(22) Filed: May 7, 2025

(51) Int. Cl. G06F 16/242; G06F 16/2452

(52) U.S. Cl. CPC G06F 16/2433; G06F 16/24522

(57) ABSTRACT

Techniques for generating and verifying Structured Query Language (SQL) queries are disclosed. In some embodiments, a system, a process, and/or a computer program product for generating and verifying SQL queries includes receiving a query that includes a user prompt associated with a user and directing the query to one of a plurality of expert modules based on content in the query using a router agent, wherein each expert module of the plurality of expert modules includes a plurality of agents; converting the user prompt into one or more optimized prompts using a prompt optimization agent; generating an SQL query based on the one or more optimized prompts and contextual information about a database using an SQL generation agent; and executing the generated SQL query against the database to generate query results and verifying whether the query results satisfy predetermined criteria using an execution and verification agent.

### BACKGROUND OF THE INVENTION

Large language models (LLMs) can help users interact with advanced databases by generating complex structured query language (SQL) queries based on a natural language prompt. Most text-to-SQL solutions that use LLMs rely on retrieval augmented generation (RAG), where examples of past SQL queries and details about the database schema (e.g., tables, columns, column descriptions) are retrieved as context to improve query generation. However, RAG solutions of this form have several pitfalls. First, they often lead to model overfitting, whereby the model replicates outputs based on limited training examples instead of generalizing to unseen scenarios. Furthermore, even in a RAG architecture, LLMs are prone to hallucinations and may output incorrect SQL queries or summaries to a user without checking for accuracy.

### BRIEF DESCRIPTION OF THE DRAWINGS

Various embodiments of the invention are disclosed in the following detailed description and the accompanying drawings.

FIG. 1 is a block diagram illustrating a system to generate a data-aware mixture of experts agentic query in accordance with some embodiments.

FIG. 2 is a block diagram illustrating a plurality of agents associated with a single expert module in accordance with some embodiments.

FIG. 3 is a flow diagram illustrating a process to generate a SQL query and output a summary based on a user prompt in accordance with some embodiments.

FIG. 4 is a flow diagram illustrating a process to modify a prompt in response to determining that a SQL query returned no data in accordance with some embodiments.

FIG. 5A and FIG. 5B provide example output from an AI copilot in accordance with some embodiments.

FIG. 6 is a flow diagram illustrating a process to generate a SQL query and output a summary based on a user prompt related to internet-of-things (IOT) security in accordance with some embodiments.

FIG. 7 provides an example of generating a data-aware mixture of experts agentic query related to IoT security in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Techniques for generating a data-aware mixture of experts agentic query are disclosed herein. Most modern text-to-SQL solutions rely primarily on RAG and often struggle with accuracy due to three primary challenges. First, it is difficult to distinguish between whether an LLM response of no data is accurate or simply reflects an error in the generated SQL query. For example, a user may prompt, “Give me the new severe IoT alerts in the last 30 days.” In response, the user may receive a summary of “No relevant security data found,” which does not indicate an error but may be the result of an error in retrieving data based on the underlying query that was generated.

A second difficulty with text-to-SQL solutions is that they are unable to automatically correct SQL errors. Many of these systems are one-shot, meaning that they provide a response to the user based on a single prompt and revise the response only based on a subsequent prompt or additional context provided. Therefore, even when SQL errors are detected, they lack a mechanism to make corrections to the errors without further prompting.

Lastly, text-to-SQL solutions are unable to automatically detect and fix hallucinations. LLM-based systems are often prone to hallucinations, which happens when generated output appears plausible to a user but in fact is incorrect or unsupported by real information. For example, a user may prompt, “Show me IoT devices in the default site” and receive a response of 1,484 while the correct output is 5,660. The LLM may have mistakenly hallucinated an additional limiting condition in the SQL query to come to the first solution, but without further investigation, the user may not realize a mistake has been made.

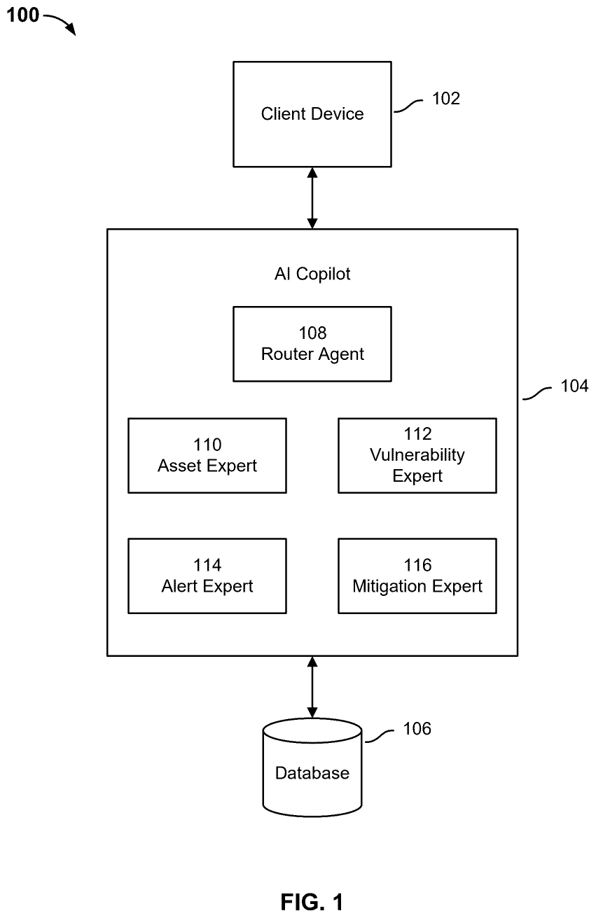

FIG. 1 is a block diagram illustrating a system to generate a data-aware mixture of experts agentic query in accordance with some embodiments. In the example shown, system 100 includes client device 102. Client device 102 may be a laptop, a tablet, a smartphone, a desktop computer, or any other device capable of interacting with AI copilot 104. In some embodiments, AI copilot is an LLM-based chat configured to receive a prompt from a user using client device 102 and output a response. In some embodiments, the prompt and response are related to IoT security.

AI copilot 104 includes router agent 108. Router agent 108 is an instance of an LLM. In response to receiving a user prompt, AI copilot 104 directs router agent 108 to select one or more expert modules of a plurality of expert modules to execute a response. Each expert module of the plurality of expert modules is configured to execute the response to a specific subset of user prompts (i.e., its area of expertise). In some embodiments, the plurality of expert modules includes asset expert 110 (which may be configured to respond to prompts related to devices, their configurations, and risk profiles, such as “list all IoT devices in the default site that use outdated firmware”), vulnerability expert 112 (which may be configured to respond to prompts related to identifying vulnerabilities in devices and their configurations, such as “what factors affect the firmware of this specific device?”), alert expert 114 (which may be configured to respond to prompts related to incidents or anomalies based on alerts and security logs, such as “what potential threats should we investigate based on the alert received at 9:13 PM?”), and mitigation expert 116 (which may be configured to respond to prompts related to responding to vulnerabilities or threats, such as “what action items might I take to mitigate the risk of smart device failure without disrupting operations in site 42?”).

Each expert module of the plurality of expert modules is further configured to respond to a user based on a specific prompt instruction related to its goal. For example, asset expert 110 may be provided with the instruction “You are an expert in IoT asset management. Your job is to accurately retrieve, describe, and reason about device inventory, configurations, network exposure, and operational status. Focus only on information about assets without speculating about vulnerabilities or incidents.” In some embodiments, the prompt instruction is provided by the developer.

AI copilot 104 is configured to interact with database 106. In some embodiments, database 106 includes a plurality of tables which itself includes a plurality of rows and columns. AI copilot 104 may utilize a database schema associated with database 106 which describes the plurality of tables and the plurality of rows and columns. Router agent 108 may utilize the database schema to determine which expert module to call upon. The expert module may utilize the database schema to generate a SQL query in response to a user prompt.

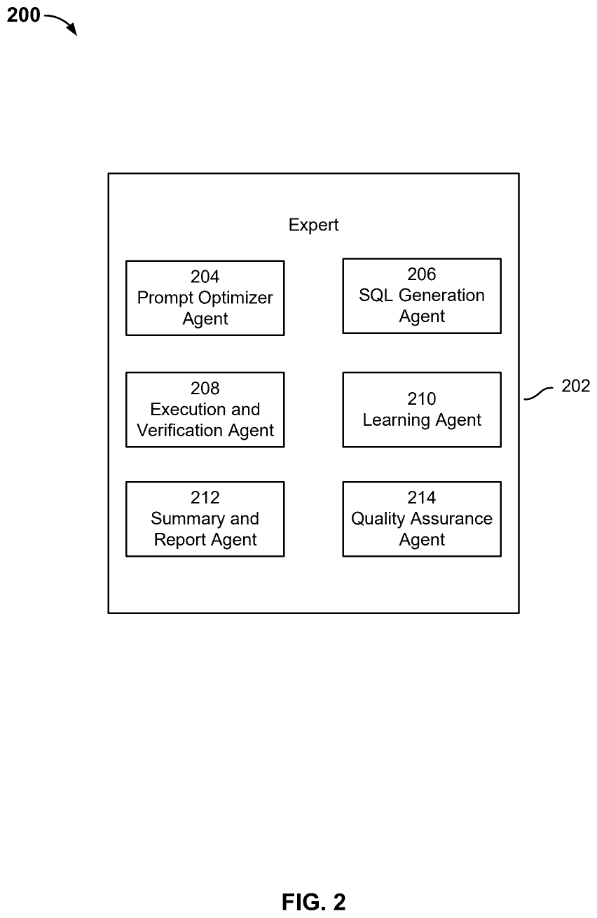

FIG. 2 is a block diagram illustrating a plurality of agents associated with a single expert module in accordance with some embodiments. In the example shown, expert 202 may be an expert module of the plurality of expert modules 110, 112, 114, and 116 associated with AI copilot 104. Responding to a user prompt expert 202 includes a plurality of agents, where each agent is responsible for part of a process to generate a SQL query and summary to a user that avoids errors and hallucinations. Each agent 204, 206, 208, 210, 212, and 214 of the plurality of agents is an instance of an LLM.

Prompt optimizer agent 204 is configured to receive a user prompt and optimize it according to the goal of generating an accurate SQL query and summary that is free from hallucinations. In some embodiments, optimizing the prompt includes modifying the user input to align with the specific requirements of the expert (i.e., utilizing macro prompt instructions according to whether the expert is an asset expert, vulnerability expert, etc.). In some embodiments, optimizing the prompt includes utilizing background context about a database schema describing a database such as database 106. In some embodiments, optimizing the prompt includes utilizing a term-attribute mapping which defines domain-specific terms and is provided by the developer (e.g., the term-attribute mapping may elaborate that “iPhone 13” in the prompt is “the 13^{th} generation model of Apple's iPhone device”).

In some embodiments, optimizing the prompt includes configuring a criticality level and a time frame to specify the request from the user.

SQL generation agent 206 is configured to receive as input the prompt as optimized by prompt optimizer agent 204 and generate a corresponding SQL query. In some embodiments, generating the SQL query includes using an LLM. In some embodiments, the LLM is accessed through an application programming interface (API).

In some embodiments, generating the SQL query includes utilizing background context about a database schema describing a database such as database 106. In some embodiments, generating the SQL query includes providing the SQL generation agent with table definitions, column definitions, a sample of real data from the database, and one or more extracted rules derived from the real data.

Execution and verification agent 208 is configured to execute the SQL query generated by SQL generation agent 206 and verify whether a response including no data is indicative of a SQL error. In some embodiments, executing the SQL query includes querying a database, such as database 106, through an API. Verifying the SQL query may include modifying the prompt. In some embodiments, modifying the prompt includes specifying a time range for the query (e.g., “in the past year”). In some embodiments, modifying the prompt includes specifying an impact level for the query (e.g., “devices which have critical risk”).

Using an execution and verification agent such as execution and verification agent 208 overcomes the first primary pitfall of most text-to-SQL solutions by providing a mechanism for distinguishing between no data outputs and SQL errors. If, by modifying the time range or impact level of the prompt, there is still no data output, then it may truly be an accurate output. In this case, a summary and report agent, such as summary and report agent 212, may be utilized. Otherwise, there is likely an error in the SQL query and a learning agent, such as learning agent 210, may be utilized.

Learning agent 210 is configured to automatically fix SQL errors. In some embodiments, learning agent 210 is provided with verification history from the execution and verification agent, such as execution and verification agent 208, as well as error logs. In some embodiments, verification outcomes are logged in a verification history table such that learning agent 210 may use them as additional context to learn from in subsequent calls.

Learning agent 210 may output suggested root causes (e.g., automatically identified root causes), updates to the SQL query, and updates to the rules and context guiding query generation and return the output to a SQL generation agent, such as SQL generation agent 206.

In some embodiments, learning agent 210 is only used following each of a threshold number of failures detected by an execution and verification agent, such as execution and verification agent 208. If SQL errors are detected more than the threshold number of times, a summary of the failure may be provided to the user. In this way, system 200 overcomes the difficulty of text-to-SQL solutions by automatically correcting SQL errors.

Summary and report agent 212 is configured to generate a summary and structured report of the user prompt and the steps that follow in providing a response. In some embodiments, the generated summary and report include steps taken to optimize the prompt by a prompt optimizer agent such as prompt optimizer agent 204. In some embodiments, the generated summary and report include steps taken to generate a SQL query by a SQL generation agent such as SQL generation agent 206. In some embodiments, the generated summary and report include steps taken to execute and verify the SQL query by an execution and verification agent such as execution and verification agent 208. In some embodiments, the generated summary and report include steps taken to learn about SQL errors and suggest root causes (e.g., automatically identified root causes) and updates to the SQL query by a learning agent such as learning agent 210. In some embodiments, the generated summary and report include device attributes, machine learning-derived risk scores, and timestamps indicating device activity within the database.

Quality assurance agent 214 is configured to receive a summary and report from a summary and report agent such as summary and report agent 212 and detect hallucinations. In some embodiments, hallucinations are detected by comparing the generated SQL query with the user prompt and expected patterns. In some embodiments, the quality assurance agent further utilizes the output of the SQL query as well as a summary of the output to detect hallucinations. If hallucinations are detected, quality assurance agent 214 may generate suggested reasons for the hallucination and updates to the SQL query and provide the suggestions to an execution and verification agent such as execution and verification agent 208. If hallucinations are not detected, the summary and report generated by summary and report agent 210 may be output to the user.

Using a quality assurance agent such as quality assurance agent 214 constitutes a further improvement over existing LLM-based text-to-SQL solutions by detecting and automatically correcting hallucinations.

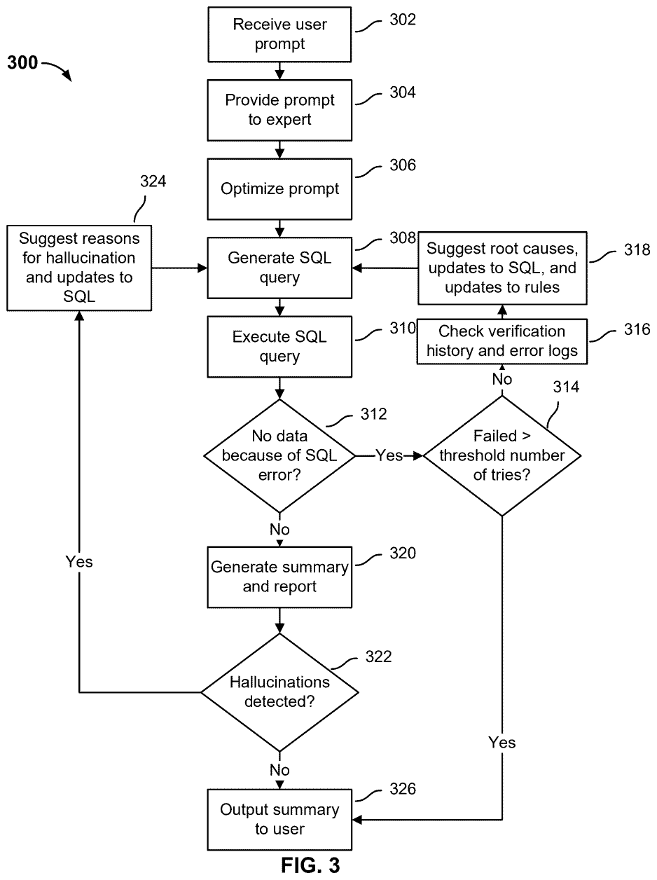

FIG. 3 is a flow diagram illustrating a process to generate a SQL query and output a summary based on a user prompt in accordance with some embodiments. Process 300 may be implemented by an AI copilot such as AI copilot 104.

At 302, a user prompt is received. In some embodiments, the user prompt is received from a user using a client device such as client device 102. In some embodiments, the prompt is related to IoT security.

At 304, the prompt is provided to a relevant expert. The prompt may be provided to a relevant expert module by a router agent, such as router agent 108. The expert may be an expert such as asset expert 110, vulnerability expert 112, alert expert 114, or mitigation expert 116.

At 306, the prompt is optimized. The prompt may be optimized by a prompt optimizer agent such as prompt optimizer agent 204.

In some embodiments, optimizing the prompt includes modifying the user input to align with the specific requirements of the expert (i.e., utilizing macro prompt instructions according to whether the expert is an asset expert, vulnerability expert, etc.). In some embodiments, optimizing the prompt includes utilizing background context about a database schema describing a database such as database 106. In some embodiments, optimizing the prompt includes utilizing a term-attribute mapping which defines domain-specific terms and is provided by the developer (e.g., the term-attribute mapping may elaborate that “iPhone 13” in the prompt is “the 13^{th} generation model of Apple's iPhone device”). In some embodiments, optimizing the prompt includes configuring a criticality level and a time frame to specify the request from the user.

At 308, a SQL query is generated. The SQL query may be generated by a SQL generation agent such as SQL generation agent 206. In some embodiments, the LLM is accessed through an API. In some embodiments, generating the SQL query includes utilizing background context about a database schema describing a database such as database 106.

At 310, the SQL query is executed. The SQL query may be executed by an execution and verification agent such as execution and verification agent 208. In some embodiments, executing the SQL query includes querying a database, such as database 106, through an API.

At 312, it is determined whether a result of no data after executing the SQL query at 310 is caused by a SQL error. Determining whether the result of no data is caused by a SQL error may be performed by an execution and verification agent such as execution and verification agent 208. Determining whether the result of no data is caused by a SQL error may include modifying the prompt. In some embodiments, modifying the prompt includes specifying a time range for the query (e.g., “in the past year”). In some embodiments, modifying the prompt includes specifying an impact level for the query (e.g., “devices which have critical risk”). In some embodiments, after modifying the prompt, process 300 returns to 306.

In response to determining that the result of no data is not caused by a SQL error, or that the result did include data either before or after modifying the prompt, process 300 proceeds to 320. In response to determining that the result of no data is caused by a SQL error, process 300 proceeds to 314.

At 314, it is determined whether a SQL error occurred more than a threshold number of tries when executing a query. The threshold number may be predetermined by a developer. In response to determining that the SQL error occurred greater than a threshold number of tries, process 300 proceeds to 316. In response to determining that the SQL error occurred fewer than the threshold number of tries, process 300 proceeds to 326.

At 316, verification history and error logs are checked. Checking verification history and error logs may be implemented by a learning agent such as learning agent 210. The verification history may be verification history collected at step 312 from prior iterations of process 300. The error logs may be collected at step 310 when the SQL query is executed. In some embodiments, the verification history is stored in a table such that the learning agent may use it as additional context to learn from in subsequent calls.

At 318, based on the verification history and error logs, root causes, updates to the SQL query, and updates to the rules and context guiding query generation by the expert module are suggested. The suggestions may be generated by a learning agent such as learning agent 210. The suggestions may be provided to a SQL generation agent such as SQL generation agent 206 at 308 to generate a new SQL query based on the suggestions.

At 320, a summary and report are generated. The summary and report may be generated by a summary and report agent such as summary and report agent 212. In some embodiments, the summary and report include information about the events occurring at the previous steps of process 300. In some embodiments, the summary and report include information about the tries taken to generate, execute, and verify a working SQL query.

At 322, it is determined, based on the summary and report generated at 320, whether hallucinations are detected. Determining whether hallucinations are detected may be implemented by a quality assurance agent such as quality assurance agent 214. In some embodiments, hallucinations are detected by comparing the user prompt and the generated SQL query. In some embodiments, the quality assurance agent further utilizes the output of the SQL query as well as a summary of the output to detect hallucinations.

In response to determining that hallucinations are detected, process 300 proceeds to 324. In response to determining that hallucinations are not detected, process 300 proceeds to 326.

At 324, reasons for the hallucination and updates to the SQL query are suggested based on the summary and report generated at 320. Suggesting reasons for hallucinations and updates to SQL may be performed by a quality assurance agent such as quality assurance agent 214. The suggestions may be provided to a SQL generation agent such as SQL generation agent 206 at 308 to generate a new SQL query based on the suggestions.

At 326, a summary is output to the user. In some embodiments, the summary output to the user is the summary and report generated at 320.

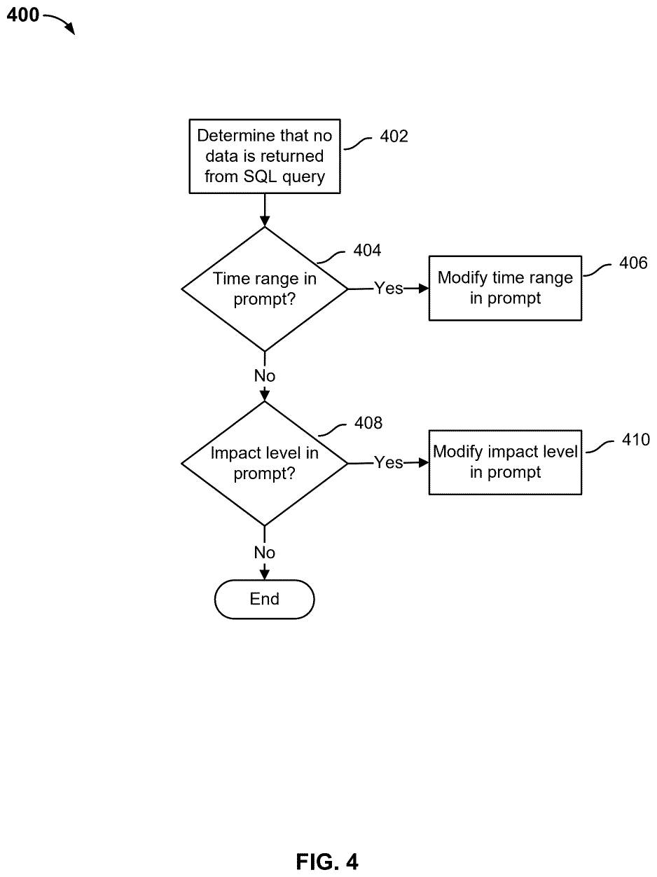

FIG. 4 is a flow diagram illustrating a process to modify a prompt in response to determining that a SQL query returned no data in accordance with some embodiments. Process 400 may be implemented by an execution and verification agent such as execution and verification agent 208. Process 400 may be implemented as part of step 312 of process 300.

At 402, it is determined that no data is returned from executing a SQL query. The SQL query may be a SQL query generated by a SQL generation agent such as SQL generation agent 206.

At 404, it is determined whether there is a time range in the user prompt which prompted the query generation. For example, the prompt “Give me the new severe IoT alerts in the last 30 days” includes a time range of “the last 30 days.” In response to determining that there is not a time range in the user prompt, process 400 proceeds to 408. In response to determining that there is a time range in the user prompt, process 400 proceeds to 406.

At 406, the time range in the prompt is modified. For example, the prompt may be modified to, “Give me the new severe IoT alerts in the last year,” changing the time range from “the last 30 days” to “the last year.”At 408, it is determined whether there is an impact level in the user prompt which prompted the query generation. For example, the prompt “Give me the printer devices which have critical risk” includes an impact level of “critical risk.” In response to determining that there is not an impact level in the user prompt, process 400 ends. In some embodiments, at this point, the user may be asked to provide a new prompt as a working SQL query could not be executed based on the original prompt. In response to determining that there is an impact level in the user prompt, process 400 proceeds to 410.

At 410, the impact level in the prompt is modified. For example, the prompt may be modified to, “Give me the printer devices which have critical or high or low or medium risk” changing the impact level from “critical risk” to “critical or high or low or medium risk.” Process 400 may therefore enable automatic correction of generated SQL queries by expanding the original user prompt to encompass more data.

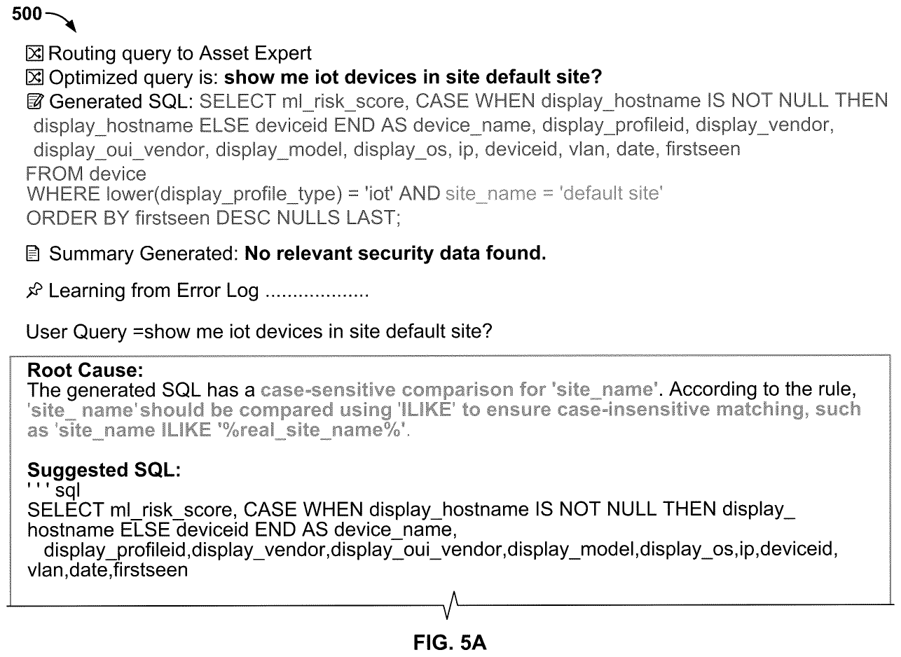

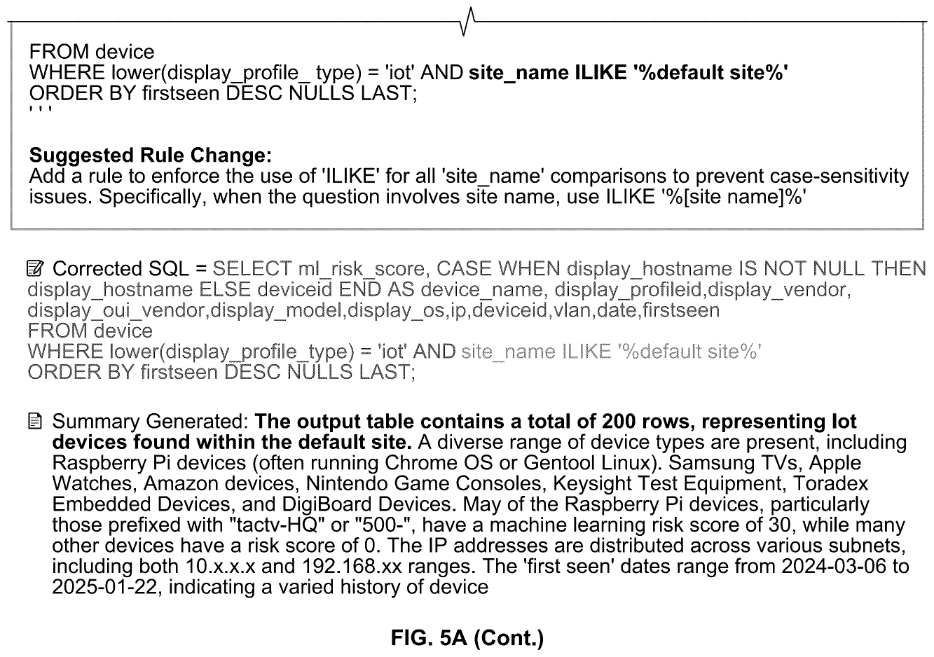

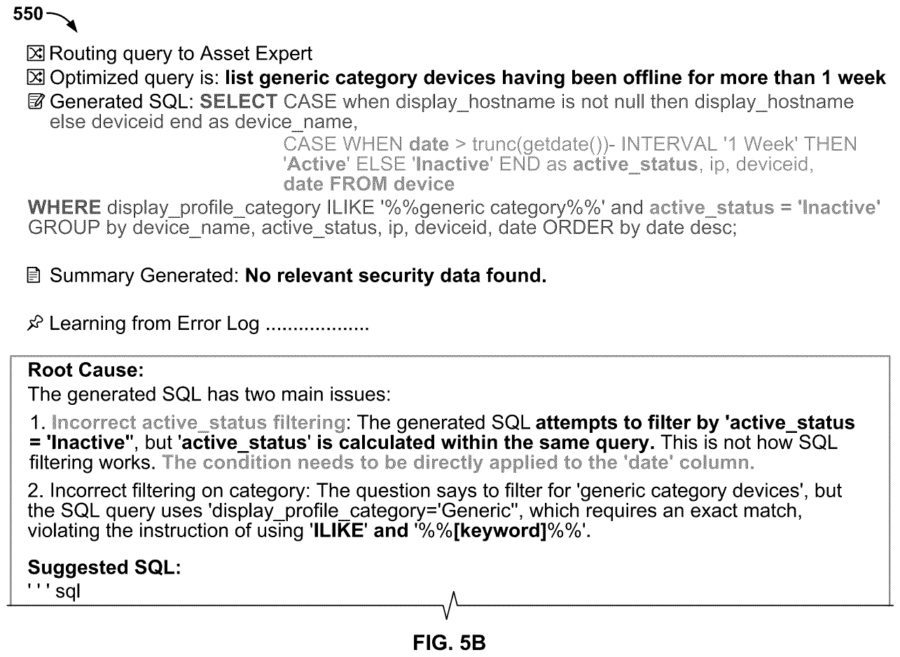

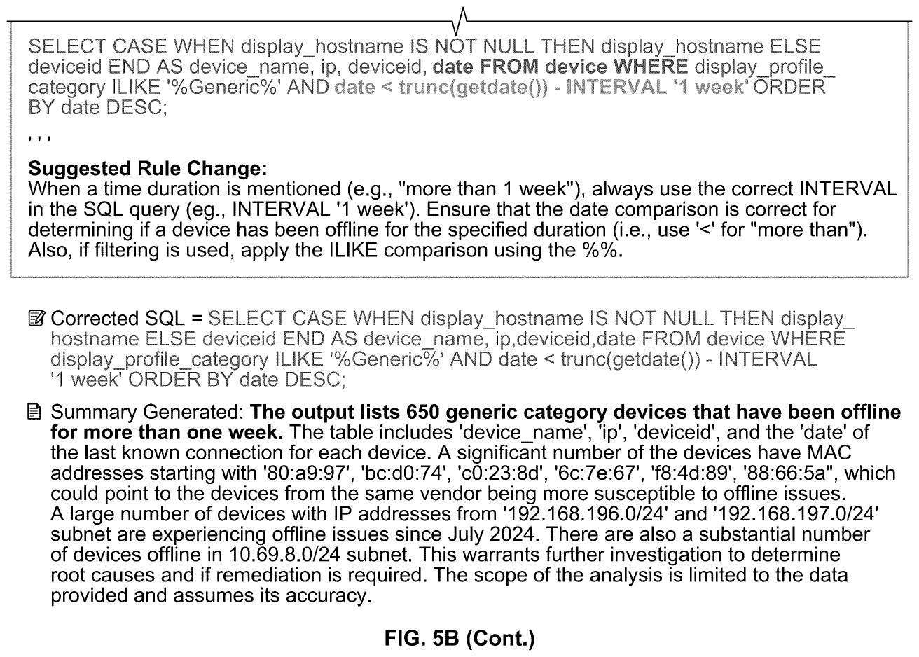

FIG. 5A provides an example output from an AI copilot in accordance with some embodiments.

In example 500, a user prompt (not shown) is routed to an asset expert such as asset expert 110, as it relates to device configurations. Next, the user prompt is optimized by a prompt optimizer agent such as prompt optimizer agent 204 to “show me IoT devices in site default site.” A SQL query is generated by a SQL generation agent such as SQL generation agent 206 to query a database such as database 106.

The generated query may then be executed by an execution and verification agent such as execution and verification agent 208. In response to an output of “No relevant security data found,” a learning agent such as learning agent 210 learns from the error log and generates a suggested root cause for the error, a suggested fix to the SQL query, and a suggested rule change for the asset expert to use in generating subsequent queries of a similar nature.

In response to executing the corrected SQL query, a summary is generated describing the results from querying the database.

FIG. 5B provides another example output from an AI copilot in accordance with some embodiments.

In example 550, a user prompt (not shown) is routed to an asset expert such as asset expert 110, as it relates to device configurations. Next, the user prompt is optimized by a prompt optimizer agent such as prompt optimizer agent 204 to “list generic category devices having been offline for more than 1 week.” A SQL query is generated by a SQL generation agent such as SQL generation agent 206 to query a database such as database 106.

The generated query may then be executed by an execution and verification agent such as execution and verification agent 208. In response to an output of “No relevant security data found,” a learning agent such as learning agent 210 learns from the error log and generates a suggested root cause for the error, a suggested fix to the SQL query, and a suggested rule change for the asset expert to use in generating subsequent queries of a similar nature.

In response to executing the corrected SQL query, a summary is generated describing the results from querying the database.

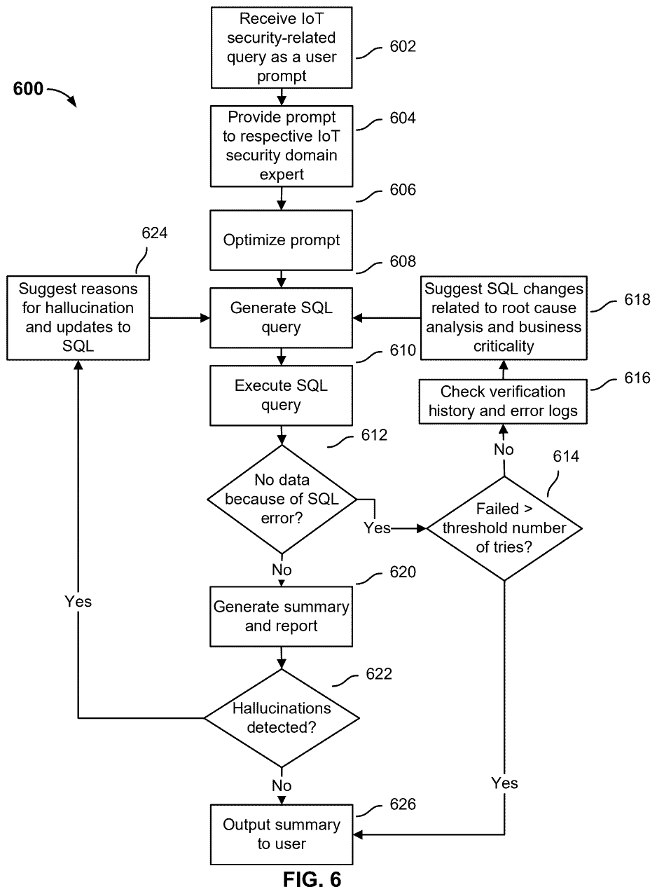

FIG. 6 is a flow diagram illustrating a process to generate a SQL query and output a summary based on a user prompt related to internet-of-things (IOT) security in accordance with some embodiments. Process 600 may be implemented by an AI copilot such as AI copilot 104.

At 602, a query related to IoT security is received as a user prompt. In some embodiments, the user prompt is received from a user using a client device such as client device 102.

At 604, the prompt is provided to a relevant IoT security domain expert. The prompt may be provided to a relevant expert module by a router agent, such as router agent 108. The expert may be an expert such as asset expert 110, vulnerability expert 112, alert expert 114, or mitigation expert 116.

At 606, the prompt is optimized. The prompt may be optimized by a prompt optimizer agent such as prompt optimizer agent 204.

At 608, a SQL query is generated. The SQL query may be generated by a SQL generation agent such as SQL generation agent 206. In some embodiments, the LLM is accessed through an API. In some embodiments, generating the SQL query includes utilizing background context about a database schema describing a database such as database 106.

At 610, the SQL query is executed. The SQL query may be executed by an execution and verification agent such as execution and verification agent 208. In some embodiments, executing the SQL query includes querying a database, such as database 106, through an API.

At 612, it is determined whether a result of no data after executing the SQL query at 610 is caused by a SQL error. Determining whether the result of no data is caused by a SQL error may be performed by an execution and verification agent such as execution and verification agent 208. Determining whether the result of no data is caused by a SQL error may include modifying the prompt. In some embodiments, modifying the prompt includes specifying a time range for the query (e.g., “in the past year”). In some embodiments, modifying the prompt includes specifying an impact level for the query (e.g., “devices which have critical risk”). In some embodiments, after modifying the prompt, process 600 returns to 606.

In response to determining that the result of no data is not caused by a SQL error, or that the result did include data either before or after modifying the prompt, process 300 proceeds to 620. In response to determining that the result of no data is caused by a SQL error, process 600 proceeds to 614.

At 614, it is determined whether a SQL error occurred more than a threshold number of tries when executing a query. The threshold number may be predetermined by a developer. In response to determining that the SQL error occurred greater than a threshold number of tries, process 600 proceeds to 626. In response to determining that the SQL error did not occur greater than the threshold number of tries, process 600 proceeds to 616.

At 616, verification history and error logs are checked. Checking verification history and error logs may be implemented by a learning agent such as learning agent 210. The verification history may be verification history collected at step 612 from prior iterations of process 300. The error logs may be collected at step 610 when the SQL query is executed. In some embodiments, the verification history is stored in a table such that the learning agent may use it as additional context to learn from in subsequent calls.

At 618, root causes, updates to the SQL query related to the root causes, and an analysis of business criticality related to the query are suggested based on the verification history and error logs. The suggestions may be generated by a learning agent such as learning agent 210. The suggestions may be provided to a SQL generation agent such as SQL generation agent 206 at 608 to generate a new SQL query based on the suggestions.

At 620, a summary and report are generated. The summary and report may be generated by a summary and report agent such as summary and report agent 212. In some embodiments, the summary and report include information about the events occurring at the previous steps of process 600. In some embodiments, the summary and report include information about the tries taken to generate, execute, and verify a working SQL query.

At 622, it is determined, based on the summary and report generated at 620, whether hallucinations are detected. Determining whether hallucinations are detected may be implemented by a quality assurance agent such as quality assurance agent 214. In some embodiments, hallucinations are detected by comparing the user prompt and the generated SQL query. In some embodiments, the quality assurance agent further utilizes the output of the SQL query as well as a summary of the output to detect hallucinations.

In response to determining that hallucinations are detected at 622, process 600 proceeds to 624. In response to determining that hallucinations are not detected, process 600 proceeds to 626.

At 624, reasons for the hallucination and updates to the SQL query are suggested based on the summary and report generated at 620. Suggesting reasons for hallucinations and updates to SQL may be performed by a quality assurance agent such as quality assurance agent 214. The suggestions may be provided to a SQL generation agent such as SQL generation agent 206 at 608 to generate a new SQL query based on the suggestions.

At 626, a summary is output to the user. In some embodiments, the summary output to the user is the summary and report generated at 620.

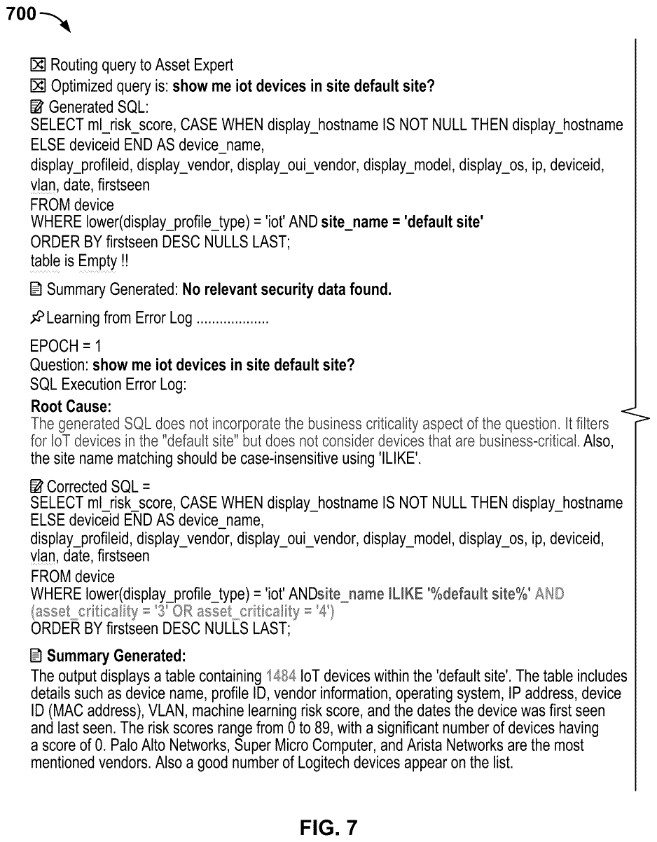

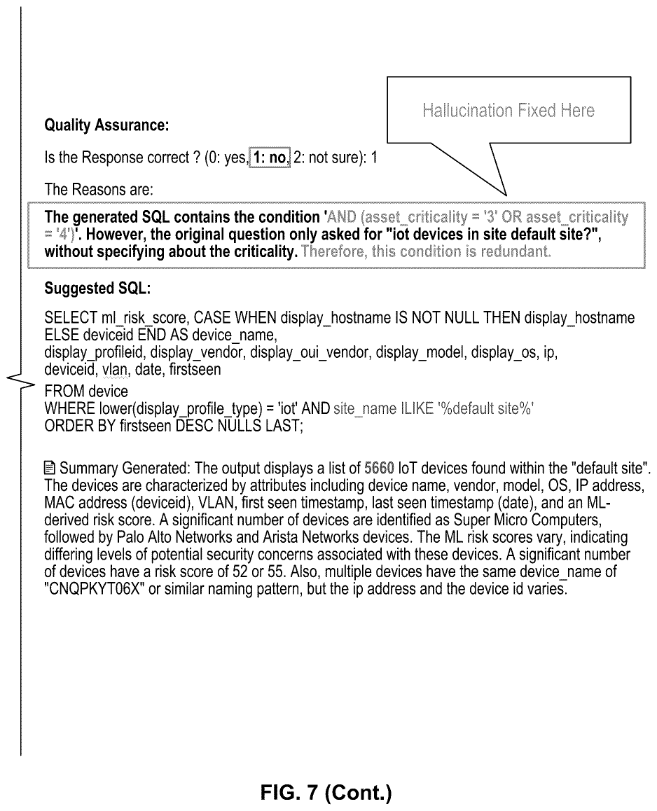

FIG. 7 provides an example of generating a data-aware mixture of experts agentic query related to IoT security in accordance with some embodiments. The example shown may be a resulting output of implementing process 600.

In example 700, a user prompt (not shown) is routed to an asset expert such as asset expert 110, as it relates to device configurations. Next, the user prompt is optimized by a prompt optimizer agent such as prompt optimizer agent 204 to “show me IoT devices in site default site.” A SQL query is generated by a SQL generation agent such as SQL generation agent 206 to query a database such as database 106.

The generated query may then be executed by an execution and verification agent such as execution and verification agent 208. In response to an output of “No relevant security data found,” a learning agent such as learning agent 210 learns from the error log and generates a suggested root cause for the error, a suggested fix to the SQL query, and a suggested rule change for the asset expert to use in generating subsequent queries of a similar nature.

In response to executing the corrected SQL query, a summary is generated describing the results from querying the database. The summary may be generated by a summary and report agent such as summary and report agent 212.

The summary is provided to a quality assurance agent such as quality assurance agent 214, which determines that the response is incorrect by comparing the generated SQL query to the original user question and reasoning that there is an added condition in the query that the user did not ask for. The quality assurance agent suggests a new SQL query which is subsequently executed and verified, and a new summary is generated.

Using a quality assurance agent to respond to user prompts adds an additional verification of accuracy, as hallucinations can exist even when there is no SQL error.

Although the foregoing embodiments have been described in some detail for purposes of clarity of understanding, the invention is not limited to the details provided. There are many alternative ways of implementing the invention. The disclosed embodiments are illustrative and not restrictive.

1. A system for generating and verifying Structured Query Language (SQL) queries, comprising:
a processor configured to:
receive a query that includes a user prompt associated with a user and direct the query to one of a plurality of expert modules based on content in the query using a router agent, wherein each expert module of the plurality of expert modules includes a plurality of agents;
convert the user prompt into one or more optimized prompts using a prompt optimization agent;
generate an SQL query based on the one or more optimized prompts and contextual information about a database using an SQL generation agent;
execute the generated SQL query against the database to generate query results and verify whether the query results satisfy predetermined criteria using an execution and verification agent; and
determine whether hallucinations are present in the query by comparing the query results against the user prompt and expected patterns using a quality assurance agent; and
a memory coupled to the processor and configured to provide the processor with instructions.

2. The system of claim 1, wherein the user prompt is related to Internet of Things (IOT) security.

3. The system of claim 1, wherein each expert module is configured to handle prompts related to a specific domain or task.

4. The system of claim 1, wherein the plurality of expert modules includes an asset expert, a vulnerability expert, an alert expert, and a mitigation expert.

5. The system of claim 1, wherein the plurality of agents includes the prompt optimization agent, the SQL generation agent, the execution and verification agent, a learning agent, a summary and report agent, and a quality assurance agent.

6. The system of claim 1, wherein each agent of the plurality of agents is an instance of a large language model (LLM).

7. The system of claim 1, wherein the contextual information about the database includes table definitions, column definitions, a sample of real data from the database, and one or more extracted rules derived from the real data.

8. The system of claim 1, wherein the processor is further configured to:
log verification outcomes in a verification history table; and
analyze the verification history table and error logs to identify root causes for errors, updates to the generated SQL query, and updates to rules and context guiding query generation in the one or the plurality of expert modules using a learning agent.

9. The system of claim 1, wherein the processor is further configured to:
determine whether a no data result is returned from executing the SQL query;
in response to determining that the no data result is returned from executing the SQL query, determine whether a time range is specified in the one or more optimized prompts; and
in response to determining that the time range is specified in the one or more optimized prompts, modify the time range specified in the one or more optimized prompts.

10. The system of claim 9, wherein the processor is further configured to:
in response to determining that the no data result is returned from executing the SQL query, determine whether an impact level is specified in the one or more optimized prompts; and
in response to determining that the time range is specified in the one or more optimized prompts, modify the impact level specified in the one or more optimized prompts.

11. The system of claim 9, wherein the processor is further configured to:
in response to determining that the no data result is returned from executing the SQL query, determine whether the no data result has been returned on greater than a threshold number of executions; and
in response to determining that the no data result has been returned on greater than the threshold number of executions, generate a summary of the execution results.

12. The system of claim 1, wherein the processor is further configured to generate a summary and a structured report of the query results using a summary and report agent.

13. The system of claim 12, wherein the summary and structured report include device attributes, machine learning-derived risk scores, and timestamps indicating device activity for devices represented in the query results generated by executing the generated SQL query against the database.

14. The system of claim 12, wherein the summary and structured report are provided to the user.

15. (canceled)

16. The system of claim 1, wherein the processor is further configured to:
in response to determining that hallucinations are present in the query, generate reasons for the hallucinations and updates to the SQL query; and
generate a new SQL query.

17. The system of claim 1, wherein the query results are provided to the user.

18. A method for generating and verifying Structured Query Language (SQL) queries, comprising:
receiving a query that includes a user prompt associated with a user and directing the query to one of a plurality of expert modules based on content in the query using a router agent, wherein each expert module of the plurality of expert modules includes a plurality of agents;
converting the user prompt into one or more optimized prompts using a prompt optimization agent;
generating an SQL query based on the one or more optimized prompts and contextual information about a database using an SQL generation agent;
executing the generated SQL query against the database to generate query results and verifying whether the query results satisfy predetermined criteria using an execution and verification agent; and
determining whether hallucinations are present in the query by comparing the query results against the user prompt and expected patterns using a quality assurance agent.

19. The method of claim 18, wherein the plurality of agents includes the prompt optimization agent, the SQL generation agent, the execution and verification agent, a learning agent, a summary and report agent, and a quality assurance agent.

20. A computer program product for generating and verifying Structured Query Language (SQL) queries embodied in a non-transitory computer readable medium and comprising computer instructions for:
receiving a query that includes a user prompt associated with a user and directing the query to one of a plurality of expert modules based on content in the query using a router agent, wherein each expert module of the plurality of expert modules includes a plurality of agents;
converting the user prompt into one or more optimized prompts using a prompt optimization agent;
generating an SQL query based on the one or more optimized prompts and contextual information about a database using an SQL generation agent;
executing the generated SQL query against the database to generate query results and verifying whether the query results satisfy predetermined criteria using an execution and verification agent; and
determining whether hallucinations are present in the query by comparing the query results against the user prompt and expected patterns using a quality assurance agent.

21. The method of claim 18, further comprising:
in response to determining that hallucinations are present in the query, generating reasons for the hallucinations and updates to the SQL query; and
generating a new SQL query.
